(19) United States
(12) Patent Application Publication
(10) Pub. No.: US 2019/0034497 A1
(43) Pub. Date: Jan. 31, 2019

(54) Data2Data: Deep Learning for Time Series Representation and Retrieval

(71) Applicant: NEC Laboratories America, Inc., Princeton, NJ (US)

(72) Inventors: Dongjin Song, Princeton, NJ (US); Ning Xia, Plainsboro, NJ (US); Haifeng Chen, West Windsor, NJ (US)

(21) Appl. No.: 15/991,205

(22) Filed: May 29, 2018

Related U.S. Application Data
(60) Provisional application No. 62/537,577, filed on Jul. 27, 2017.

(51) Int. Cl. G06F 17/30; G06F 17/11; G06F 15/18

(52) U.S. Cl. CPC G06F 17/30551; G06F 17/11; G06F 15/18; G06F 17/30949; G06F 17/30554

(57) ABSTRACT

A computer-implemented method for employing deep learning for time series representation and retrieval is presented. The method includes retrieving multivariate time series segments from a plurality of sensors, storing the multivariate time series segments in a multivariate time series database constructed by a sliding window over a raw time series of data, applying an input attention based recurrent neural network to extract real value features and corresponding hash codes, executing similarity measurements by an objective function, given a query, obtaining a relevant time series segment from the multivariate time series segments retrieved from the plurality of sensors, and generating an output including a visual representation of the relevant time series segment on a user interface.

### RELATED APPLICATION INFORMATION

This application claims priority to Provisional Application No. 62/537,577, filed on Jul. 27, 2017, incorporated herein by reference in its entirety.

### BACKGROUND

### Technical Field

The present invention relates to deep neural networks and, more particularly, to methods and systems for performing multivariate time series retrieval with respect to large scale historical data.

### Description of the Related Art

Multivariate time series data are becoming common in various real world applications, e.g., power plant monitoring, traffic analysis, health care, wearable devices, automobile fault detection, etc. Therefore, multivariate time series retrieval, e.g., given a current multivariate time series segment and how to find the most relevant time series segments in historical data, play an important role in understanding the current status of the system. Although a great amount of effort has been made to investigate the similarity search problem in machine learning and data mining, multivariate time series retrieval remains challenging because in real world applications a large number of time series needs to be considered and each time series may include more than one million or even a billion timestamps.

### SUMMARY

A computer-implemented method for employing deep learning for time series representation and retrieval is presented. The method includes retrieving multivariate time series segments from a plurality of sensors, storing the multivariate time series segments in a multivariate time series database constructed by a sliding window over a raw time series of data, applying an input attention based recurrent neural network to extract real value features and corresponding hash codes, executing similarity measurements by an objective function, given a query, obtaining a relevant time series segment from the multivariate time series segments retrieved from the plurality of sensors, and generating an output including a visual representation of the relevant time series segment on a user interface.

A system for employing deep learning for time series representation and retrieval is also presented. The system includes a memory and a processor in communication with the memory, wherein the processor is configured to retrieve multivariate time series segments from a plurality of sensors, store the multivariate time series segments in a multivariate time series database constructed by a sliding window over a raw time series of data, apply an input attention based recurrent neural network to extract real value features and corresponding hash codes, execute similarity measurements by an objective function, given a query, obtain a relevant time series segment from the multivariate time series segments retrieved from the plurality of sensors, and generating an output including a visual representation of the relevant time series segment on a user interface.

A non-transitory computer-readable storage medium comprising a computer-readable program is presented for employing deep learning for time series representation and retrieval, wherein the computer-readable program when executed on a computer causes the computer to perform the steps of retrieving multivariate time series segments from a plurality of sensors, storing the multivariate time series segments in a multivariate time series database constructed by a sliding window over a raw time series of data, applying an input attention based recurrent neural network to extract real value features and corresponding hash codes, executing similarity measurements by an objective function, given a query, obtaining a relevant time series segment from the multivariate time series segments retrieved from the plurality of sensors, and generating an output including a visual representation of the relevant time series segment on a user interface.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a training stage of the Data2Data engine, in accordance with embodiments of the present invention;

FIG. 2 is a block/flow diagram illustrating a test stage of the Data2Data engine, in accordance with embodiments of the present invention;

FIG. 3 is a block/flow diagram illustrating an input attention based recurrent neural network (LSTM/GRU) algorithm for feature extraction, in accordance with embodiments of the present invention;

FIG. 4 is a block/flow diagram illustrating a Data2Data engine employing a pairwise loss supervised feature extraction model or a triplet loss supervised feature extraction model, in accordance with embodiments of the present invention;

FIG. 5 is a block/flow diagram illustrating a pairwise loss, in accordance with embodiments of the present invention;

FIG. 6 is a block/flow diagram illustrating a triplet loss, in accordance with embodiments of the present invention;

FIG. 7 is a block/flow diagram illustrating a method for employing a deep neural network supervised by pairwise loss or triplet loss, in accordance with embodiments of the present invention;

FIG. 8 is an exemplary processing system for employing a deep neural network supervised by pairwise loss or triplet loss, in accordance with embodiments of the present invention; and

FIG. 9 is a block/flow diagram of exemplary IoT sensors used to collect data/information by employing the input attention based recurrent neural network (LSTM/GRU) algorithm, in accordance with embodiments of the present invention.

### DETAILED DESCRIPTION OF PREFERRED EMBODIMENTS

In the exemplary embodiments of the present invention, methods and devices are presented for representing multivariate time series data and retrieving time series segments in historical data. The exemplary embodiments of the present invention employ two deep learning approaches based upon an input attention based long short term memory/gated recurrent unit (LSTM/GRU) algorithm. In particular, the input attention mechanism is utilized to adaptively select relevant input time series and the LSTM/GRU is used to extract corresponding temporal features. In addition, the extracted features are binarized as hash codes which are supervised by a pairwise loss or a triplet loss. The pairwise loss produces similar hash codes for similar pairs and produces dissimilar hash codes for dissimilar pairs. Meanwhile, the triplet loss (e.g., anchor, positive, negative) can be employed to ensure that a Hamming distance between anchor and positive is less than a Hamming distance between anchor and negative.

In the exemplary embodiments of the present invention, methods and devices are provided for employing a Data2Data engine or module to perform efficient multivariate time series retrieval with respect to large scale historical data (located in a history database). In the training stage, given input multivariate time series segments, an input attention based recurrent neural network (LSTM/GRU) can be employed to extract real value features as well as hash codes (for indexing) supervised by a pairwise loss or a triplet loss. Both real value features and their corresponding hash codes are jointly learned in an end-to-end manner in the deep neural networks. In the test stage, given a multivariate time series segment query, the Data2Data engine or module can automatically generate relevant real value features as well as hash codes of the query and return the most relevant time series segments in the historical data.

In the exemplary embodiments of the present invention, methods and devices are provided for capturing the long-term temporal dependencies of multivariate time series by employing an input attention based LSTM/GRU algorithm. The method can provide effective and compact (higher quality) representations of multivariate time series segments, can generate discriminative binary codes (more effective) for indexing multivariate time series segments, and, given a query time series segment, can obtain the relevant time series segments with higher accuracy and efficiency.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

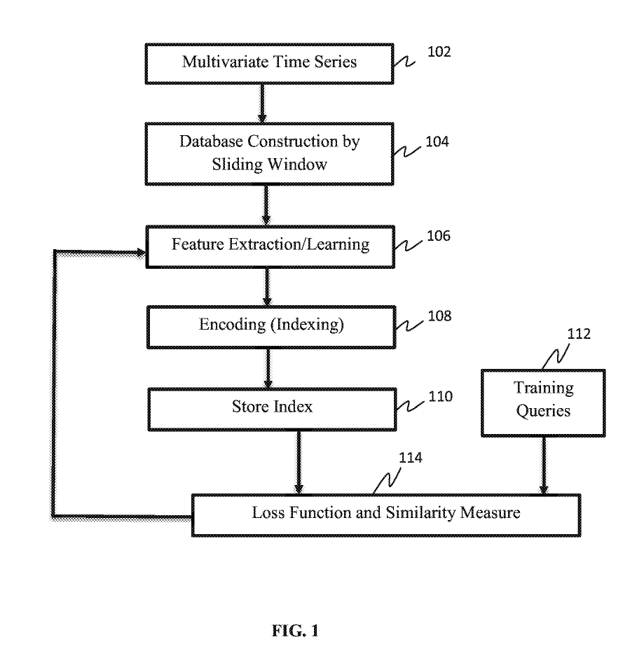

FIG. 1 is a block/flow diagram illustrating a training stage of the Data2Data engine, in accordance with embodiments of the present invention.

At block 102, in a training stage, a training input is a multivariate time series.

At block 104, a database is constructed by a sliding window (e.g., window size can be 90, 180, 360, etc.) over a raw time series to obtain or acquire time series segments.

At block 106, feature extraction is conducted by an input attention based LSTM/GRU algorithm to obtain a fixed size feature vector for each time series segment.

At block 108, hash codes are obtained by utilizing tanh( )and sign( )functions.

At block 110, hash codes are stored in a database (e.g., a hash code database).

At block 112, hash codes of training queries and database hash codes are evaluated based upon a loss function.

At block 114, the loss function is used to supervise the feature extraction and binary code generation.

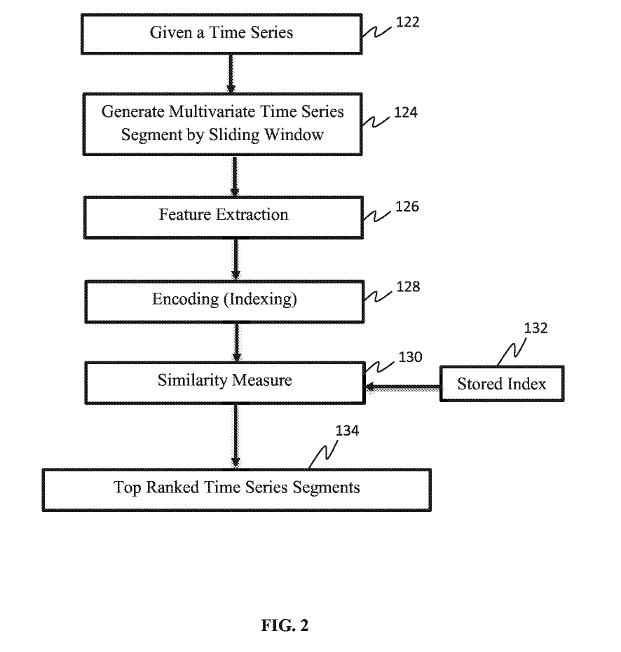

FIG. 2 is a block/flow diagram illustrating a test stage of the Data2Data engine, in accordance with embodiments of the present invention.

At block 122, in a test stage, a test input is a multivariate time series.

At block 124, a multivariate time series segment is generated by a sliding window (e.g., window size can be 90, 180, 360, etc.) over a raw time series.

At block 126, feature extraction is conducted by an input attention based LSTM/GRU algorithm to obtain a fixed size feature vector for each time series segment.

At block 128, hash codes are obtained by utilizing tanh( )and sign( )function.

At block 130, similarity measurements of a query index (hash codes) are determined.

At block 132, indexes are stored in a database (e.g., an index database).

At block 134, an output can be top ranked time series segments retrieved from the historical data (e.g., history database). The output can be generated to include a visual representation of the relevant time series segment on a user interface (e.g., one or more displays). The visual representation can include a plurality of relevant time series segments that are displayed adjacent to each other or in an overlapping manner (e.g., in a graphical format). Thus, the visual representation can be one graph or multiple graphs. The visual representations can be manipulated or changed or adjusted to suit the needs of the consumer. Patterns can be identified between visual representations and can be stored in a relevant time series segment pattern database. In one example, instead of encoding data to basic graphical primitives such as points, lines, or bars that are aligned with the time axis, the methods can also also create fully fledged visual representations and align multiple thumbnails of them along the time axis.

The user or consumer can change the visualization method of the relevant time series segments. Such relevant time series segments can be displayed in a number of configurations to create different specialized or custom databases. Customized databases can be created and employed to quickly and efficiently access various information extracted from the relevant time series segments.

Regarding FIGS. 1 and 2, a recurrent neural network is employed. A recurrent neural network (RNN) is a class of artificial neural network where connections between units form a directed graph along a sequence. This allows RNNs to exhibit dynamic temporal behavior for a time sequence. Unlike feedforward neural networks, RNNs can use their internal state (memory) to process sequences of inputs. Recurrent neural networks are used somewhat indiscriminately about two broad classes of networks with a similar general structure, where one is finite impulse and the other is infinite impulse. Both classes of networks exhibit temporal dynamic behavior. A finite impulse recurrent network is a directed acyclic graph that can be unrolled and replaced with a strictly feedforward neural network, while an infinite impulse recurrent network is a directed cyclic graph that cannot be unrolled.

Both finite impulse and infinite impulse recurrent networks can have additional stored state, and the storage can be under direct control by the neural network. The storage can also be replaced by another network or graph, if that incorporates time delays or has feedback loops. Such controlled states are referred to as gated state or gated memory, and are part of long short term memory (LSTM) and gated recurrent units (GRU).

LSTM is a deep learning system that avoids the vanishing gradient problem. LSTM is usually augmented by recurrent gates called “forget” gates. LSTM prevents backpropagated errors from vanishing or exploding. Instead, errors can flow backwards through unlimited numbers of virtual layers unfolded in space. That is, LSTM can learn tasks that require memories of events that happened thousands or even millions of discrete time steps earlier.

Gated recurrent units (GRUs) are a gating mechanism in recurrent neural networks . GRUs are employed in the full form and several simplified variants. GRUs performance on speech signal modeling was found to be similar to that of long short-term memory. GRUs have fewer parameters than LSTM, as GRUs lack an output gate.

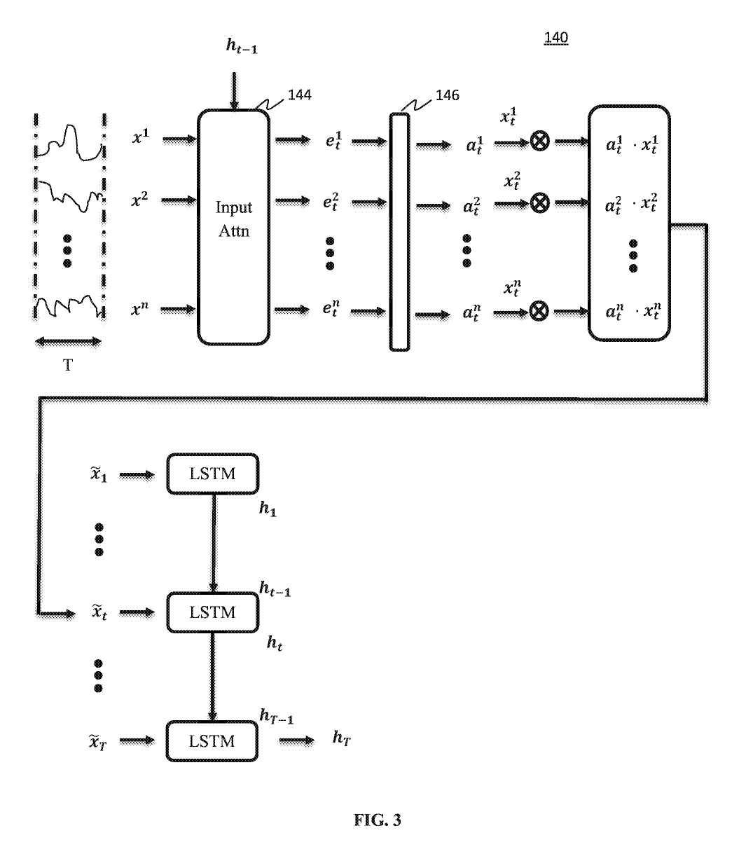

FIG. 3 is a block/flow diagram 140 illustrating an input attention based recurrent neural network (LSTM/GRU) algorithm for feature extraction, in accordance with embodiments of the present invention.

In a first step, besides LSTM/GRU, an input attention mechanism 1447 is also used to adaptively extract relevant time series at each time step by referring to the previous encoder hidden state. In a second step, the input attention based LSTM/GRU is used to extract best representation for multivariate time series segments.

Two deep learning algorithms are presented to perform a multivariate time series retrieval task with input attention based LSTM/GRU.

Concerning notations:

Given n time series, e.g.,

x=(x¹,x², . . . , xⁿ)^{T}=(x¹,x² , . . . , x^{T}) ∈ [symbol] ^{n×T,}

where T is a length of a window size, the exemplary methods use x^{k}=(x₁^{k}, x₂^{k}, . . . , x_{T}^{k})^{T} ∈ [symbol] ^{T} to represent a time series of length T and employ xₜ=(xₜ¹, xₜ², . . . , xₜⁿ)^{T} ∈ [symbol] ⁿ to denote a vector of n input series at time t.

Concerning input attention:

Inspired by the theory that the human attention system can select elementary stimulus features in early stages of processing, the exemplary embodiments of the present invention introduce an input attention-based encoder that can adaptively select the relevant driving series, which is of practical meaning in time series prediction.

Given the k-th input time series x^{k}=(x₁^{k}, x₂^{k}, . . . , x_{T}^{k})^{T} ∈ [symbol] ^{T}, an input attention mechanism 144 can be constructed via a deterministic attention model, e.g., a multilayer perceptron, by referring to the previous hidden state hₜ₋₁ and the cell state sₜ₋₁ in the encoder LSTM/GRU unit with:

$$\begin{matrix}{e}_{t}^{k} = {v}_{e}^{T} tanh ( {W}_{e} [ {h}_{i - 1} ; {s}_{t - 1} ] + {U}_{e} {x}^{k} ) & ( 1 ) \\ and & \\ {α}_{t}^{k} = \frac{exp ( {e}_{t}^{k} )}{{\sum }_{i = 1}^{n} exp ( {e}_{t}^{i} )} , & ( 2 )\end{matrix}$$

Where vₑ ∈ [symbol] ^{T}, Wₑ ∈ [symbol] ^{T×2m} and Uₑ ∈ [symbol] ^{T×T} are parameters to learn. The bias terms in Eqn. (1) are omitted to be succinct.

αₜ^{k} is the attention weight measuring the importance of the k-th input feature (driving series) at time t.

A softmax function 146 is applied to eₜ^{k} to ensure all the attention weights sum to 1.

The input attention mechanism 144 is a feed forward network that can be jointly trained with other components of the RNN.

With these attention weights, the driving series can be adaptively extracted with:

\tilde{x}ₜ=(αₜ¹xₜ¹, αₜ²xₜ², . . . , αₜⁿxₜⁿ)^{T}. (3)

Concerning LSTM/GRU for feature extraction:

The encoder is essentially an RNN that encodes the input sequences into a feature representation in machine translation. For time series prediction, given the input sequence x=(x₁, x₂, . . . , x_{T}) with xₜ ∈ [symbol] ⁿ, where n is the number of driving (exogenous) series, the encoder can be applied to learn a mapping from xₜ to hₜ (at time step t) with:

hₜ=ƒ₁(hₜ₋₁,xₜ), (4)

Where hₜ ∈ [symbol] ^{rn} is the hidden state of the encoder at time t, m is the size of the hidden state, and ƒ₁ is a non-linear activation function that could be a long short term memory (LSTM) or gated recurrent unit (GRU). An LSTM unit is employed as ƒ₁ to capture long-term dependencies. Each LSTM unit has a memory cell with the state sₜ at time t. Access to the memory cell can be controlled by three sigmoid gates: forget gate fₜ, input gate iₜ and output gate oₜ.

The update of an LSTM unit can be summarized as follows:

fₜ=σ(W_{ƒ}[hₜ₋₁; xₜ]+b_{ƒ}) (5)

iₜ=σ(Wᵢ[hₜ₋₁; xₜ]+bᵢ) (6)

oₜ=σ(Wₒ[hₜ₋₁; xₜ]+bₒ) (7)

sₜ=fₜ⊙sₜ₋₁+iₜ ⊙tan h(Wₛ[hₜ₋₁; xᵢ]+bₛ) (8)

hₜ=oₜ ⊙tan h(sₜ) (9)

Where [hₜ₋₁; xₜ]∈ [symbol] ^{m+n} is a concatenation of the previous hidden state hₜ₋₁ and the current input xₜ.

W_{ƒ}, Wᵢ, Wₒ, Wₛ ∈ [symbol] ^{m×(m+n)}, and b_{ƒ}, bᵢ, bₒ, bₛ ∈ [symbol] ^{m} are parameters to learn. σ and ⊙ are a logistic sigmoid function and an element-wise multiplication, respectively. The reason for using an LSTM unit is that the cell state sums activities over time, which can overcome the issue of vanishing gradients and better capture long-term dependencies of time series.

Then the hidden state at time t can be updated as:

hₜ=ƒ₁(hₜ₋₁, \tilde{x}ₜ), (10)

where ƒ₁ is an LSTM unit that can be computed according to Eqn. (3)-(7) with xₜ replaced by the newly computed \tilde{x}ₜ. With the proposed input attention mechanism 144, the encoder can selectively focus on certain driving series rather than treating all the input driving series equally.

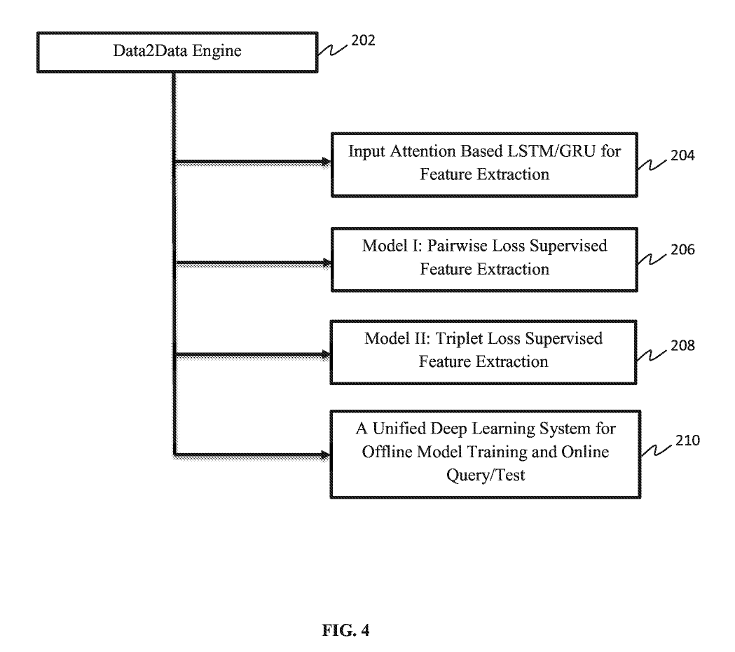

FIG. 4 is a block/flow diagram illustrating a Data2Data engine employing a pairwise loss supervised feature extraction model or a triplet loss supervised feature extraction model, in accordance with embodiments of the present invention.

The Data2Data engine 202 can perform efficient multivariate time series retrieval by employing an input attention based LSTM/GRU for feature extraction module 204. The input attention based LSTM/GRU for feature extraction module 204 can implement either a pairwise loss supervised feature extraction model 206 or a triplet loss supervised feature extraction model 208. This can be accomplished by employing a unified deep learning system 210 for offline model training and online query/test.

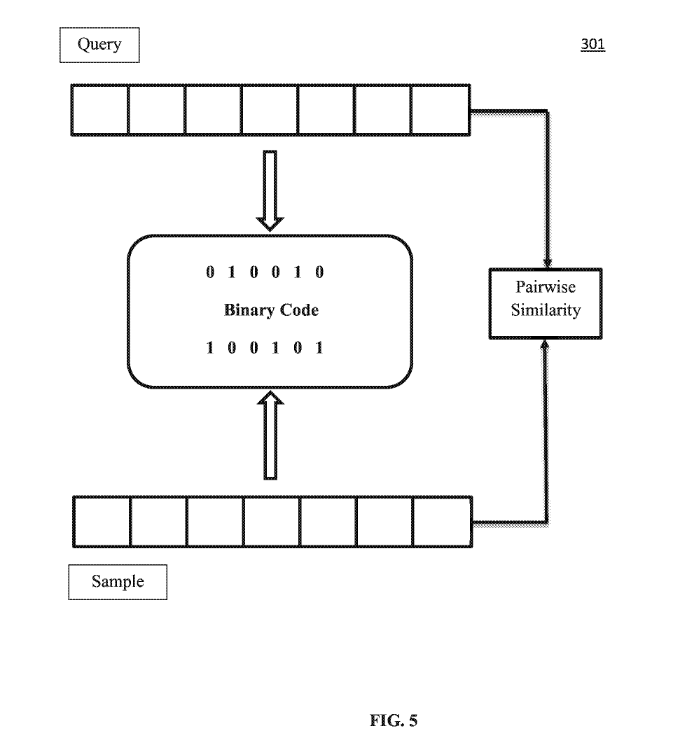

FIG. 5 is a block/flow diagram 301 illustrating a pairwise loss, in accordance with embodiments of the present invention.

In a first step, input attention based LSTM/GRU is employed to extract a best representation for multivariate time series segments. In a second step, pairwise loss is used as the objective function to ensure that similar pair should produce similar hash codes and dissimilar pair should produce dissimilar hash codes.

Specifically, assuming that the method includes query i and sample j, if they are a similar pair (Sᵢⱼ=1), then p(Sᵢⱼ|B)=σ(Ωᵢⱼ) where, Ωᵢⱼ is the inner product of the hash codes of query i, e.g., b(hᵢ) and that of sample j, i.e., b(hⱼ).

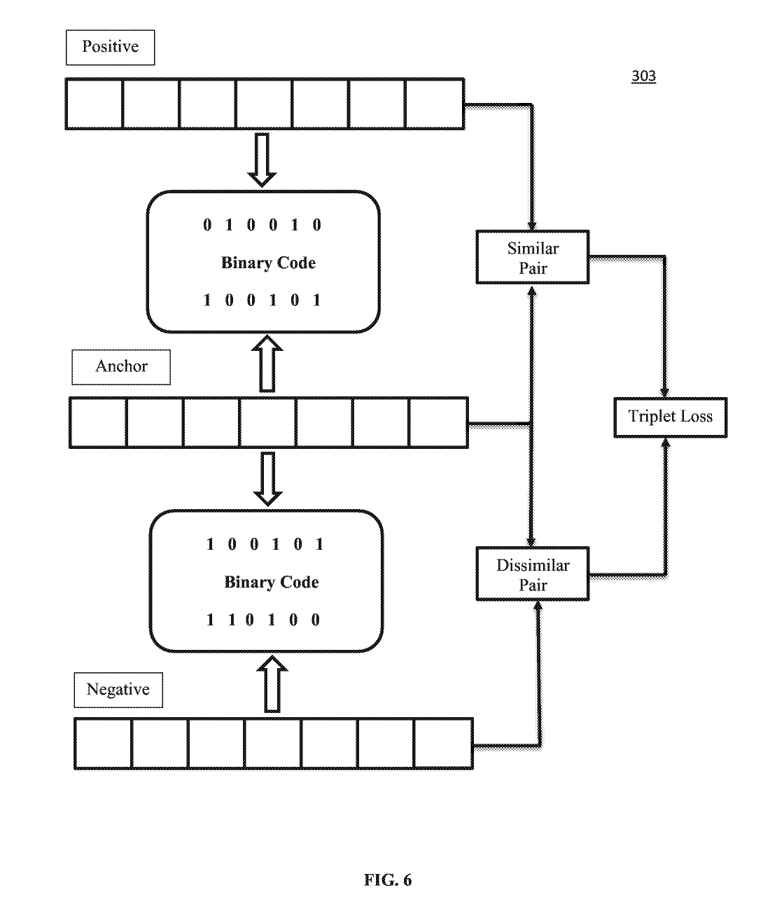

FIG. 6 is a block/flow diagram 303 illustrating a triplet loss, in accordance with embodiments of the present invention.

In a first step, input attention based LSTM/GRU is employed to extract a best representation for multivariate time series segments. In a second step, triplet loss is used as the objective function to ensure that given a triplet of (anchor, positive, negative), a Hamming distance between anchor and positive is less than a Hamming distance between anchor and negative.

Given a triplet of (anchor (A), positive(P), and negative(N)), a Hamming distance between anchor and positive should be smaller than the anchor and negative. Specifically, a hinge loss is minimized to enforce this relationship, e.g.,

|∥b(A)−b(P)∥−∥b(N)∥+α|₊ (11)

Where α is the margin.

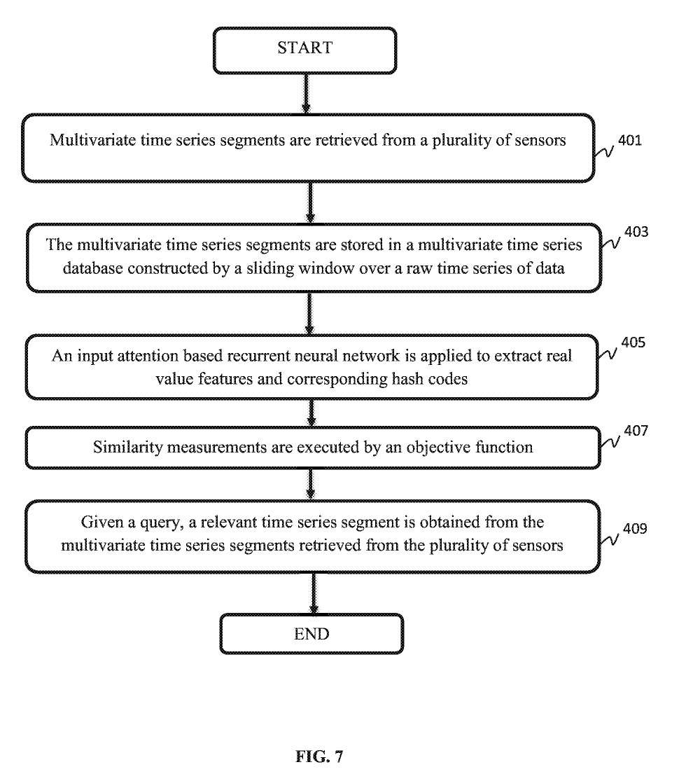

FIG. 7 is a block/flow diagram illustrating a method for employing a deep neural network supervised by pairwise loss or triplet loss, in accordance with embodiments of the present invention.

At block 401, multivariate time series segments are retrieved from a plurality of sensors.

At block 403, the multivariate time series segments are stored in a multivariate time series database constructed by a sliding window over a raw time series of data.

At block 405, an input attention based recurrent neural network is applied to extract real value features and corresponding hash codes.

At block 407, similarity measurements are executed by an objective function.

At block 409, given a query, a relevant time series segment is obtained from the multivariate time series segments retrieved from the plurality of sensors.

In conclusion, two deep learning algorithms are employed, e.g., a pairwise loss supervised input attention based LSTM/GRU algorithm and a triplet loss supervised input attention based LSTM/GRU algorithm for time series retrieval. The real value features and their corresponding hash codes are jointly learned in an end-to-end manner. With these two methods, (1) the method can capture the long-term temporal dependencies of multivariate time series by using input attention based LSTM/GRU; (2) the method can produce effective and compact (higher quality) representations of multivariate time series segments; (3) the method can generate discriminative binary codes (more effective) for indexing multivariate time series segments, and (4) given a query time series segment, the method can obtain the relevant time series segments with higher accuracy and efficiency.

Therefore, rather than considering feature extraction and similarity measurements separately, the Data2Data engine or module considers feature extraction and similarity measurements jointly by employing a unified deep neural network framework supervised by pairwise loss or triplet loss. Moreover, rather than utilizing LSTM/GRU to extract feature from raw time series segment, Data2Data engine or module employs input attention based LSTM/GRU to obtain a better representation of the raw time series segment. As a result, given current multivariate time series segments, the goal is to find the most relevant time series segment in the historical database in order to better understand the system.

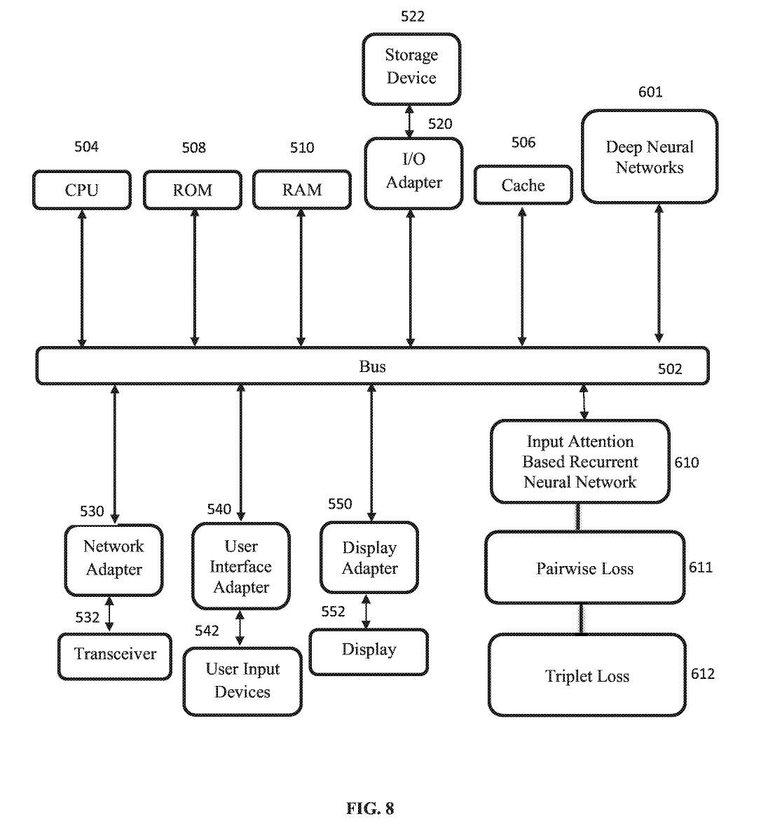

FIG. 8 is an exemplary processing system for employing a deep neural network supervised by pairwise loss or triplet loss, in accordance with embodiments of the present invention.

The processing system includes at least one processor (CPU) 504 operatively coupled to other components via a system bus 502. A cache 506, a Read Only Memory (ROM) 508, a Random Access Memory (RAM) 510, an input/output (I/O) adapter 520, a network adapter 530, a user interface adapter 540, and a display adapter 550, are operatively coupled to the system bus 502. Additionally, a deep neural network 601 is operatively coupled to the system bus 502. The deep neural network 601 can be an input attention based recurrent neural network 610 supervised by a pairwise loss 611 or a triplet loss 612.

A storage device 522 is operatively coupled to system bus 502 by the I/O adapter 520. The storage device 522 can be any of a disk storage device (e.g., a magnetic or optical disk storage device), a solid state magnetic device, and so forth.

A transceiver 532 is operatively coupled to system bus 502 by network adapter 530.

User input devices 542 are operatively coupled to system bus 502 by user interface adapter 540. The user input devices 542 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 542 can be the same type of user input device or different types of user input devices. The user input devices 542 are used to input and output information to and from the processing system.

A display device 552 is operatively coupled to system bus 502 by display adapter 550.

Of course, the deep neural network processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the deep neural network processing system are readily contemplated by one of ordinary skill in the art given the teachings of the present invention provided herein.

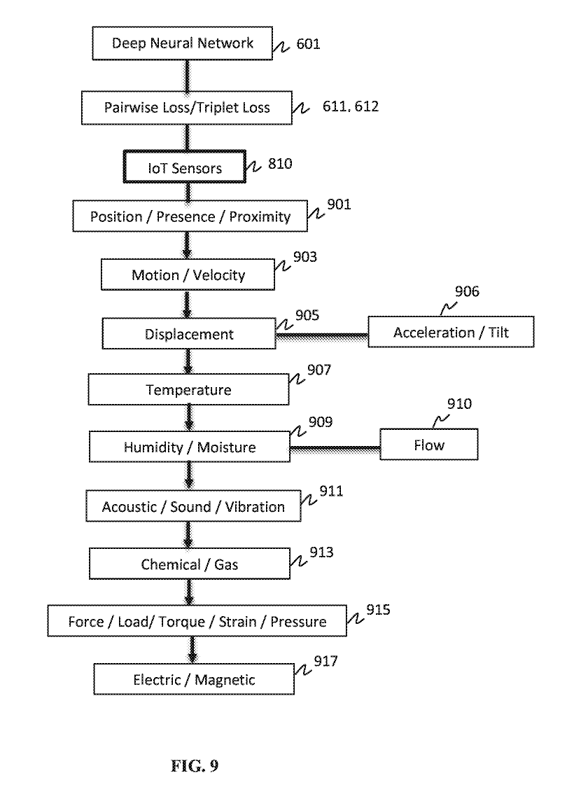

FIG. 9 is a block/flow diagram of exemplary IoT sensors used to collect data/information by employing the input attention based recurrent neural network (LSTM/GRU) algorithm, in accordance with embodiments of the present invention.

In the past decade, multivariate time series data are becoming increasingly common in various real world application. For instance, in smart power plant, a large number of sensors can be deployed in each component to monitor the status of the power plant; in health care, multiple sensors (e.g., heart rate monitoring devices) could be utilized to inspect the health condition of individuals; in an automobile, a plurality of sensors could be planted into the automobile to monitor the operational condition of each part. Therefore, how to analyze these multivariate data so as to obtain an accurate understanding of the current system status becomes relevant and advantageous.

According to some exemplary embodiments of the invention, a Data 2 Data engine is implemented using an IoT methodology, in which a large number of ordinary items are utilized in the vast infrastructure of a data mining system.

IoT enables advanced connectivity of computing and embedded devices through internet infrastructure. IoT involves machine-to-machine communications (M2M), where it is important to continuously monitor connected machines to detect any anomaly or bug, and resolve them quickly to minimize downtime.

IoT loses its distinction without sensors. IoT sensors act as defining instruments which transform IoT from a standard passive network of devices into an active system capable of real-world integration.

The IoT sensors 810 can be connected via the deep neural network 601 to transmit information/data, continuously and in in real-time. Exemplary IoT sensors 810 can include, but are not limited to, position/presence/proximity sensors 901, motion/velocity sensors 903, displacement sensors 905, such as acceleration/tilt sensors 906, temperature sensors 907, humidity/moisture sensors 909, as well as flow sensors 910, acoustic/sound/vibration sensors 911, chemical/gas sensors 913, force/load/torque/strain/pressure sensors 915, and/or electric/magnetic sensors 917. One skilled in the art can contemplate using any combination of such sensors to collect data/information and input into the modules 610, 611, 612 of the deep neural network 601 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed on a processor for employing deep learning for time series representation and retrieval, the method comprising:
retrieving multivariate time series segments from a plurality of sensors;
storing the multivariate time series segments in a multivariate time series database constructed by a sliding window over a raw time series of data;
applying an input attention based recurrent neural network to extract real value features and corresponding hash codes;
executing similarity measurements by an objective function;
given a query, obtaining a relevant time series segment from the multivariate time series segments retrieved from the plurality of sensors; and
generating an output including a visual representation of the relevant time series segment on a user interface.

2. The method of claim 1, wherein the objective function is a pairwise loss.

3. The method of claim 2, wherein the pairwise loss ensures that similar pairs produce similar has codes and that dissimilar pairs produce dissimilar hash codes.

4. The method of claim 1, wherein the objective function is a triplet loss.

5. The method of claim 4, wherein the triplet loss ensures that a triplet of anchor, positive, and negative, and that a hamming distance between the anchor and the positive is less than a hamming distance between the anchor and negative.

6. The method of claim 1, further comprising obtaining the hash codes by employing a tanh( ) function and a sign( ) function.

7. The method of claim 1, further comprising representing each multivariate time series segment as a fixed size feature vector via the input attention based recurrent neural network.

8. A system for employing deep learning for time series representation and retrieval, the system comprising:
a memory; and
a processor in communication with the memory, wherein the processor runs program code to:
retrieve multivariate time series segments from a plurality of sensors;
store the multivariate time series segments in a multivariate time series database constructed by a sliding window over a raw time series of data;
apply an input attention based recurrent neural network to extract real value features and corresponding hash codes;
execute similarity measurements by an objective function;
given a query, obtain a relevant time series segment from the multivariate time series segments retrieved from the plurality of sensors; and
generate an output including a visual representation of the relevant time series segment on a user interface.

9. The system of claim 8, wherein the objective function is a pairwise loss.

10. The system of claim 9, wherein the pairwise loss ensures that similar pairs produce similar has codes and that dissimilar pairs produce dissimilar hash codes.

11. The system of claim 8, wherein the objective function is a triplet loss.

12. The system of claim 11, wherein the triplet loss ensures that a triplet of anchor, positive, and negative, and that a hamming distance between the anchor and the positive is less than a hamming distance between the anchor and negative.

13. The system of claim 8, wherein the hash codes are obtained by employing a tanh( ) function and a sign( ) function.

14. The system of claim 8, wherein each multivariate time series segment is represented as a fixed size feature vector via the input attention based recurrent neural network.

15. A non-transitory computer-readable storage medium comprising a computer-readable program for employing deep learning for time series representation and retrieval, wherein the computer-readable program when executed on a computer causes the computer to perform the steps of:
retrieving multivariate time series segments from a plurality of sensors;
storing the multivariate time series segments in a multivariate time series database constructed by a sliding window over a raw time series of data;
applying an input attention based recurrent neural network to extract real value features and corresponding hash codes;
executing similarity measurements by an objective function;
given a query, obtaining a relevant time series segment from the multivariate time series segments retrieved from the plurality of sensors; and
generating an output including a visual representation of the relevant time series segment on a user interface.

16. The non-transitory computer-readable storage medium of claim 15, wherein the objective function is a pairwise loss.

17. The non-transitory computer-readable storage medium of claim 16, wherein the pairwise loss ensures that similar pairs produce similar has codes and that dissimilar pairs produce dissimilar hash codes.

18. The non-transitory computer-readable storage medium of claim 15, wherein the objective function is a triplet loss.

19. The non-transitory computer-readable storage medium of claim 18, wherein the triplet loss ensures that a triplet of anchor, positive, and negative, and that a hamming distance between the anchor and the positive is less than a hamming distance between the anchor and negative.

20. The non-transitory computer-readable storage medium of claim 15, wherein the hash codes are obtained by employing a tanh( ) function and a sign( ) function.
